(19) United States
(12) Patent Application Publication
(10) Pub. No.: US 2026/0356190 A1
(43) Pub. Date: Nov. 12, 2026

(54) HYDROGEN FUELING SYSTEMS WITH MULTIPLE FUEL SOURCES

(71) Applicant: Cummins Inc., Columbus, IN (US)

(72) Inventors: J. Steven Kolhouse, Columbus, IN (US); Richard J. Ancimer, Toronto (CA); Jennifer Kay Light-Holets, Greenwood, IN (US)

(21) Appl. No.: 19/124,985

(22) PCT Filed: Oct. 23, 2023
(86) PCT No.: PCT/US2023/077502

§ 371 Date: Apr. 28, 2025

Related U.S. Application Data
(60) Provisional application No. 63/382,157, filed on Nov. 3, 2022.

(51) Int. Cl. B60K 15/03; F02D 19/06; F02D 41/00

(52) U.S. Cl. CPC B60K 15/03006; B60K 2015/03118; B60K 2015/03315; B60K 2015/03427; F02D 19/0628; F02D 41/0027

(57) ABSTRACT

Hydrogen fuel systems and methods are disclosed that include solid hydrogen fuel storage and gaseous fuel storage that are controlled to provide gaseous hydrogen fuel to a prime mover. The fuel system includes a first fuel tank including a solid hydrogen fuel convertible to a gaseous hydrogen fuel and a second fuel tank including a gaseous fuel. The first fuel tank includes a first outlet, and the second fuel tank includes a second outlet for supplying the gaseous fuel to the prime mover. The first outlet of the first fuel tank supplies the converted gaseous hydrogen fuel to the second fuel tank or to the prime mover.

### CROSS-REFERENCE TO RELATED APPLICATION

The present application claims the benefit of the filing date of, and priority to, U.S. Provisional Application Ser. No. 63/382,157 filed on Nov. 3, 2022, which is incorporated herein by reference.

### FIELD OF THE INVENTION

The present invention relates generally to fuel systems for prime movers, and more particularly is concerned with systems and methods for prime movers fueled with gaseous fuel including hydrogen gaseous fuel.

### BACKGROUND

Hydrogen fueled prime movers receive gaseous hydrogen fuel from a pressurized supply of hydrogen gas. The pressurized hydrogen is stored in one or more tanks, and is delivered to the prime mover from the tank at a controlled rate and timing. For vehicular applications, multiple tanks can be used to increase the range of the vehicle between fuel re-fills. Available infrastructure to provide re-fill locations is also a constraint.

The use of multiple tanks for storage of gaseous hydrogen fuel or other gaseous fuel types requires space on the vehicle to accommodate the multiple tanks. In addition, multiple tanks add weight to the vehicle. Therefore, there is a need to improved storage and delivery of gaseous fuel to prime movers.

### SUMMARY

Systems and methods are disclosed for managing hydrogen fuel from various fuel tanks that are used to fuel a prime mover associated with a vehicle or piece of equipment. In an embodiment, a fuel system for a prime mover includes a first fuel tank including a solid hydrogen fuel convertible to a gaseous hydrogen fuel and a second fuel tank including a gaseous fuel. The first fuel tank includes a first outlet, and the second fuel tank includes a second outlet for supplying the gaseous fuel to the prime mover. The first outlet of the first fuel tank supplies the converted gaseous hydrogen fuel to the second fuel tank or to the prime mover

In an embodiment, a method for fueling a hydrogen powered prime mover includes converting solid hydrogen fuel stored in a first fuel tank to gaseous hydrogen fuel; and providing the gaseous hydrogen fuel to the prime mover or to a second fuel tank that stores gaseous fuel for delivery to the prime mover.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

FIG. 1 is a schematic illustration of embodiment of a vehicle that includes a prime mover and a hydrogen fuel system.

FIG. 2 is a schematic illustration of another embodiment hydrogen fuel system.

FIG. 3 is a schematic illustration of another embodiment hydrogen fuel system.

FIG. 4 is a flow diagram of an embodiment of a procedure for operating a hydrogen fuel system.

FIG. 5 is a flow diagram of another embodiment of a procedure for operating a hydrogen fuel system.

### DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

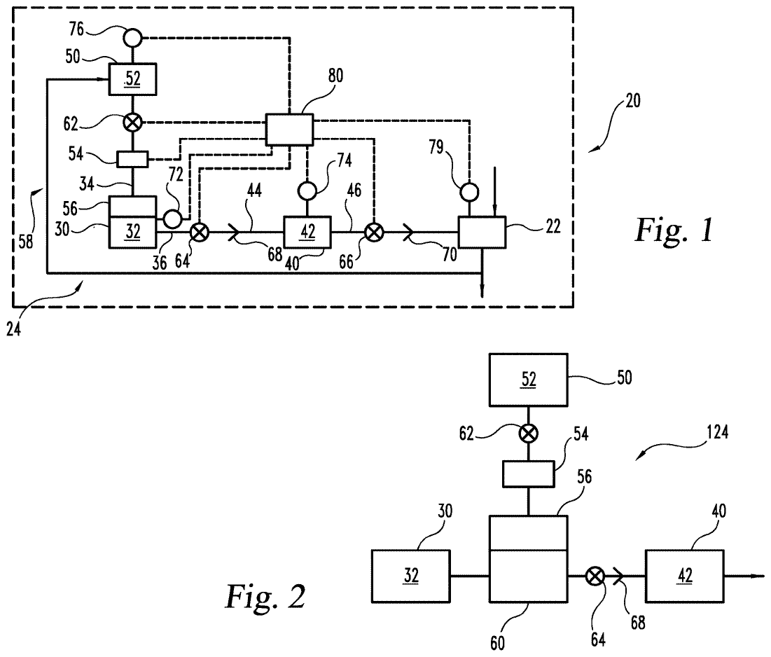

Referring to FIGS. 1-3, a fuel system 24, 24′, 124 for a prime mover 22 is disclosed. The fuel system 24, 24′, 124 includes a first fuel tank 30 including a solid hydrogen fuel 32 convertible to a gaseous hydrogen fuel. The first fuel tank 30 includes a first outlet 36. The fuel system 24, 24′, 124 includes a second fuel tank 40 including gaseous fuel 42. The second fuel tank 40 includes a second outlet 46 for supplying the gaseous fuel 42 to the prime mover 22. The first outlet 36 supplies the converted gaseous hydrogen fuel to the second fuel tank 40 or to the prime mover 22.

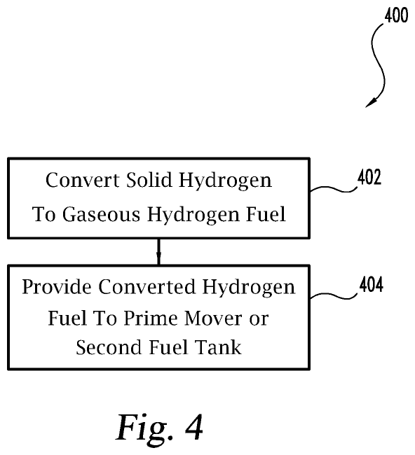

Referring further to FIG. 4, a method 400 for fueling a hydrogen powered prime mover 22 is disclosed. The method 400 includes an operation 402 to convert solid hydrogen fuel 32 stored in the first fuel tank 30 to gaseous hydrogen fuel. The method 400 includes an operation 404 to provide the gaseous hydrogen fuel to the prime mover 22 or to a second fuel tank 40 that provides gaseous fuel 42 to the prime mover 22.

With reference to FIG. 1, a vehicle 20 is shown that includes a prime mover 22 and a hydrogen fuel system 24. Hydrogen fuel system 24 includes a first fuel tank 30 for storing a solid hydrogen fuel 32, and a second fuel tank 40 for storing a gaseous fuel 42. Gaseous fuel 42 can be gaseous hydrogen fuel, natural gas, propane, or other gaseous fuel. Vehicle 20 is shown in schematic form and may be an on-road vehicle, off-road vehicle, equipment, marine vessel, or other device that is powered by prime mover 22. Prime mover 22 may be an internal combustion engine, motor, fuel cell, or combination thereof that is operable with gaseous hydrogen fuel, along or in combination with other gaseous fuel types, to provide output power for use in operating vehicle 20. Other embodiments contemplate non-vehicular applications, such as for generators and stationary equipment powered by prime mover 22.

In an embodiment of hydrogen fuel system 24, the solid hydrogen fuel 32 is any hydrogen stored in a solid phase that can be converted or gasified to a gaseous hydrogen fuel by addition of one or more conversion agents, such as heat and/or water. Embodiments of the present disclosure contemplated any other type of conversion agent(s) that are capable of converting solid hydrogen to hydrogen gas. In addition, any type of solid hydrogen storage is contemplated, including storage in solid or semi-solid forms such as, for example, a putty, a paste, a slurry, granules, tablets, blocks, a substrate or layer on another material, a composite, etc. Exampled of solid hydrogen storage mediums include, for example, a metal hydride such as magnesium hydride. Solid hydrogen fuel 32 can be stored in any suitable manner, including by chemisorption, physisorption, or any other process.

Aspects of the present disclosure also have application with fuel systems with other types of gaseous fuel solid storage media. For example, first fuel tank 30 can include a solid methane fuel that is stored as a hydrate and converted with conversion agent 52 into gaseous methane fuel. The gaseous methane fuel can be provided to second fuel tank 40 and/or directly to the prime mover in a parallel type system. Therefore, in an embodiment, solid hydrogen fuel 32 is any gaseous fuel solid storage media.

In the arrangement of FIG. 1, the solid hydrogen fuel 32 is stored in first fuel tank 30 separately from the gaseous fuel 42 stored in second fuel tank 40. This allows the rate and amount of gaseous hydrogen fuel produced from first fuel tank 30 to be different from the rate and amount of gaseous fuel 42 supplied to prime mover 22 from second fuel tank 40. The gaseous fuel 42 can be gaseous fuel produced from solid hydrogen fuel 32 that is received into second fuel tank 40 as converted solid hydrogen fuel 32 from first fuel tank 30 and/or that is placed into second fuel tank 40 from a re-filling station such as during a fuel tank re-filling or fuel tank replacement event. A third tank 50 may be provided for storing a conversion agent 52.

In an embodiment, conversion agent 52 is water that is heated to a temperature to produce gaseous hydrogen fuel from the solid hydrogen fuel 32. The temperature of conversion agent 52 can be controlled within limits to support the desired production rate of gaseous hydrogen fuel from solid hydrogen fuel 32. For example, the temperature of the conversion agent can be controlled so that the solid hydrogen fuel 32 is heated to more than 200 degrees Celsius to initiate conversion of solid hydrogen to gaseous hydrogen. In an embodiment, the temperature of the conversion agent can be controlled so that the solid hydrogen fuel 32 is heated to more than 240 degrees Celsius to initiate conversion of solid hydrogen to gaseous hydrogen. In an embodiment, the temperature of the conversion agent can be controlled so that the solid hydrogen fuel 32 is heated to about 250 degrees Celsius to initiate conversion of solid hydrogen to gaseous hydrogen. The heat can be supplied, for example, from operation of prime mover 22, an electric heater, heat exchanger, circulation of coolant that cools prime mover 22, a chiller, a waste stream from prime mover 22, cooled exhaust gas from prime mover 22, etc.

In an embodiment, the temperature or temperature limits of the conversion agent 52 are adjusted in response to the production rate not meeting the desired production rate. The desired production rate can be, for example, any rate of production of gaseous hydrogen fuel that re-fills second fuel tank 40 in a desired or required window of time, a rate that is based on a consumption of gaseous hydrogen fuel by prime mover 22, or a rate satisfies some other mission or operating requirement. In an embodiment, conversion agent 52 may be any suitable substance, compound, heat, energy source, technique, etc. capable of releasing or producing gaseous hydrogen fuel from solid hydrogen fuel 32. In an embodiment, the temperature control of conversion agent 52 varies depending on the type of conversion agent 52 that is employed.

In an embodiment, third tank 50 can be filled manually with externally sourced water or other conversion agent 52. In an embodiment, third tank 50 is additionally or alternatively filled by a condensate collector 58. Condensate collector 58 can collect water or other conversion agent produced by operation of or combustion process of prime mover 22. Condensate collector 58 includes plumbing, pumps, valves, etc. that are configured to return the collected conversion agent 52 to third tank 50. In an embodiment, additives such as corrosion inhibitors, reaction agents, etc. are added to the third tank 50 to support storage and use of conversion agent 52 to produce gaseous hydrogen fuel.

In FIG. 1 first fuel tank 30 includes a first inlet 34 for receiving the conversion agent 52. A pump and/or filter unit 54 can be provided to pump and/or filter the conversion agent 52 upstream of first fuel tank 30. The conversion agent 52 is provided from pump and/or filter unit 54 to metering and injection unit 56. The metering and injection unit 56 may include a meter to control the amount of conversion agent that is provided to first fuel tank 30, and an injector to inject the metered amount of conversion agent 52 into first fuel tank 30. In an embodiment, metering and injection unit 56 includes multiple injectors of the same or different type.

The first fuel tank 30 includes a first outlet 36 to provide the converted solid hydrogen fuel 32 to second fuel tank 40 as gaseous hydrogen fuel. First fuel tank 30 can be provide with a closeable opening to allow insertion of the solid hydrogen fuel 32 at re-filling, and/or configured to be removed and replaced with another first fuel tank 30 that is filled with solid hydrogen fuel 32 at re-filling.

In an alternate embodiment of fuel system 24 such as shown in FIG. 2, fuel system 124 includes a reactor 60 that receives a controlled amount solid hydrogen fuel 32 that is fed from first fuel tank 30 at a controlled rate. The metering and injection unit 56 provides conversion agent 52 to the reactor 60 to convert the desired amount of solid hydrogen fuel 32 into gaseous hydrogen fuel that is supplied to second fuel tank 40. The reactor 60 could be configured to be pre-heated to the desired operating temperature to provide the required heat input to facilitate conversion to the gaseous hydrogen fuel. The operating temperature of reactor 60 can be controlled within limits to support the desired production rate of gaseous hydrogen fuel from solid hydrogen fuel 32.

In an embodiment, first fuel tank 30 is pre-packaged with conversion agent 52. The amount, quality, and type of conversion agent 52 can be precisely controlled to release gaseous hydrogen fuel from the solid hydrogen fuel 32. A separate metering and injection unit 56 may not be required in such an arrangement.

Second fuel tank 40 includes a second inlet 44 for receiving gaseous hydrogen fuel produced by converting solid hydrogen fuel 32 from first fuel tank 30. Second fuel tank 40 also includes a second outlet 46 connected to prime mover 22 to provide gaseous fuel 42 thereto. Second fuel tank 40 may also include one or more other inlets (not shown) for re-filling with gaseous fuel 42 from a fueling station. Alternatively or additionally, second fuel tank 40 can be re-filled by replacement with another second fuel tank 40 that is filled with gaseous fuel 42.

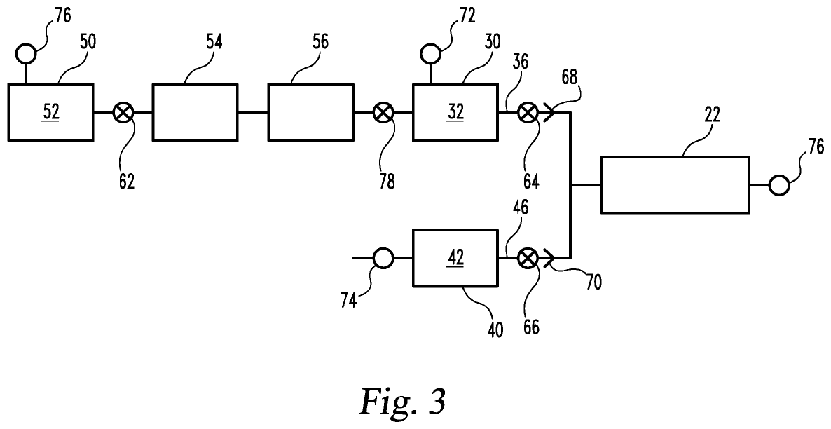

In an embodiment, fuel system 24 is a parallel system, such as shown with hydrogen fuel system 24′ in FIG. 3, rather than a series system, as shown in FIG. 1 with respect to hydrogen fuel system 24. In the parallel hydrogen fuel system 24′ the outlets 36, 46 separately provide gaseous fuel to the connected to prime mover 22 so that gaseous hydrogen fuel can provided from only first fuel tank 30, so that gaseous fuel is provided only from second fuel tank 40, or both to provide a blend of gaseous fuels from both sources.

In any of the embodiments of FIGS. 1-3, heat may be applied to conversion agent 52 in third tank 50 and/or upstream of or at metering and injection unit 56. The heat can be supplied, for example, from operation of prime mover 22, an electric heater, heat exchanger, circulation of coolant that cools prime mover 22, a chiller, a waste stream from prime mover 22, cooled exhaust gas from prime mover 22, etc. In an embodiment, heating of conversion agent 52 is initiated in response to a cold start condition, cold ambient condition, conversion agent temperature, or other condition. The amount of heat applied can be controlled based on the desired rate of production of gaseous hydrogen fuel from the solid hydrogen fuel 32.

In any of the embodiments of FIGS. 1-3, a controller 80 such as shown in FIG. 1 can be provided with hydrogen fuel system 24, 24′, 124 to track various parameters associated with the vehicle 20, prime mover 22, solid hydrogen fuel 32, and/or gaseous fuel 42, as discussed further below. Controller 80 may be, for example, part of a control unit for prime mover 22; part of a vehicle control unit for vehicle 20; a control unit dedicated to hydrogen fuel system 24, 24′, 124; a stand-alone controller; a remote controller or server; or a combination of one or more of these.

In certain embodiments of the hydrogen fuel systems 24, 24′, 124 disclosed herein, controller 80 is structured to perform certain operations to control fueling of prime mover 22 from fuel tanks 30 and/or 40 to provide the desired operational outcomes. In certain embodiments, the controller 80 forms a portion of a processing subsystem including one or more computing devices having memory, processing, and communication hardware. The controller 80 may be a single device or a distributed device, and the functions of the controller 80 may be performed by hardware or instructions provided on a computer readable storage medium. The controller 80 may be included within, partially included within, or completely separated from an engine controller (not shown). The controller 80 is in communication with any sensor or actuator throughout the systems disclosed herein, including through direct communication, communication over a datalink, and/or through communication with other controllers or portions of the processing subsystem that provide sensor and/or actuator information to the controller 80.

Example and non-limiting elements in communication with controller 80 include sensors providing any value determined herein, sensors providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), and/or digital control elements.

One of ordinary skill in the art, having the benefit of the disclosures herein, will recognize that the controllers, control systems and control methods disclosed herein are structured to perform operations that improve various technologies and provide improvements in various technological fields. Without limitation, example and non-limiting technology improvements include improvements in hydrogen fuel systems, improvements in utilization of solid hydrogen fuel to power a prime mover 22, improvements in emissions reductions from prime movers, and/or improvements in performance or operation of aftertreatment systems and/or components of prime movers. Without limitation, example and non-limiting technological fields that are improved include the technological fields of hydrogen fuel systems and related apparatuses and systems as well as prime movers that power vehicles and/or equipment including the same.

Certain operations described herein include operations to receive, record, interpret, and/or to determine one or more parameters. Recording, interpreting, or determining, as utilized herein, includes receiving values by any method known in the art, including at least receiving values from a datalink or network communication, receiving an electronic signal (e.g. a voltage, frequency, current, or PWM signal) indicative of the value, receiving a computer generated parameter indicative of the value, reading the value from a memory location on a non-transient computer readable storage medium, receiving the value as a run-time parameter by any means known in the art, and/or by receiving a value by which the parameter can be calculated, and/or by referencing a default value that is interpreted to be the parameter value.

The schematic flow descriptions which follow provide illustrative embodiments of methods for managing and controlling hydrogen fuel systems 24, 24′, 124 associated with a prime mover 22. The fuel system 24, 24′, 124 may be controlled, depending on the embodiment, to provide a gaseous hydrogen fuel or gaseous fuel from a selected fuel tank 30 or 40; a blended gaseous fuel from two or more fuel tanks 30, 40; or a gaseous fuel only from a single fuel tank 40. Operations illustrated are understood to be exemplary only, and operations may be combined or divided, and added or removed, as well as re-ordered in whole or part, unless stated explicitly to the contrary herein. Certain operations illustrated may be implemented by a computer or controller apparatus embodiment of controller 80 executing a computer program product on a non-transient computer readable storage medium, where the computer program product comprises instructions causing the computer to execute one or more of the operations, or to issue commands to other devices to execute one or more of the operations.

Controller 80 can be connected to actuators, switches, valves, meters, sensors, readers, cameras, transmitters, receivers, or other devices associated with fuel tanks 30, 40. Controller 80 is configured to provide control commands thereto that regulate the amount, timing and duration of the flows of the gaseous hydrogen fuel from fuel tanks 30, 40. Controller 80 is also configured to receive information about the hydrogen fuel stored in and provided from each of the fuel tanks 30, 40 from one or more data sources. Example data sources include, for example, re-fueling station computers, another computer or controller associated with prime mover 22 such as an engine control unit, tags (such as RFID tags) or codes (such as bar codes or quick response codes) provided on a fuel tank, a hydrogen fuel dispenser used to re-fill the fuel tank, a computer or network associated with a platoon or fleet manager, a computer server or network associated with a vehicle owner, and/or an intelligent transportation system computer network.

In FIG. 1, hydrogen fuel system 24 includes a first control valve 62 between third tank 50 and pump and/or filter unit 54. A second control valve 64 may be provided between first fuel tank 30 and second fuel tank 40, and a third control valve 66 may be provided between second fuel tank 40 and prime mover 22. In addition, a first check valve 68 can be provided between first fuel tank 30 and second fuel tank 40, and a second check valve 70 can be provided between second fuel tank 40 and prime mover 22. First fuel tank 30 may also include a first pressure sensor 72 to provide one or more solid hydrogen fuel parameters, and second fuel tank 40 may include a second pressure sensor 74 to provide one or more gaseous fuel parameters. Third tank 50 may also include a sensor(s) 76 to provide one or more parameters of conversion agent 52, such as level, pressure, temperature, etc.

In the parallel hydrogen fuel system 24′ of FIG. 3, check valves, control valves, and/or pressure sensors may be similarly provided. For example, first control valve 62 is provided between third tank 50 and pump and/or filter unit 54. Second control valve 64 is provided at the outlet of first fuel tank 30, and third control valve 66 is provided at the outlet of second fuel tank 40. The second and third control valves 64, 66 can be paired with first and second check valves 68, 70 to control gaseous fuel flow to prime mover 22 from respective ones of the fuel tanks 30, 40. First fuel tank 30 may also include first pressure sensor 72, and second fuel tank 40 may include second pressure sensor 74. In either series or parallel configuration, prime mover 22 may include sensor 79 to provide one or more operating parameters associated with prime mover 22.

Referring to FIG. 4, a method 400 for operation of hydrogen fuel system 24, 24′, and/or hydrogen fuel system 124 is shown for fueling a hydrogen powered prime mover 22. Method 400 includes an operation 402 to convert solid hydrogen fuel 32 stored in first fuel tank 30 to gaseous hydrogen fuel. Method 400 includes an operation 404 to provide the converted gaseous hydrogen fuel to the prime mover 22 or to the second fuel tank 40.

In an embodiment of method 400, the solid hydrogen fuel 32 is stored in first fuel tank 30 upstream of second fuel tank 40. The second fuel tank 40 is re-filled with gaseous fuel 42 produced from the solid hydrogen fuel 32 stored in first fuel tank 30. In an embodiment, the re-filling of second fuel tank 40 is initiated in response to a pressure condition, temperature condition, and/or fuel level in second fuel tank 40 falling below a threshold. In an embodiment, the re-filling of second fuel tank 40 occurs during operation of prime mover 22 and/or during operation of vehicle 20.

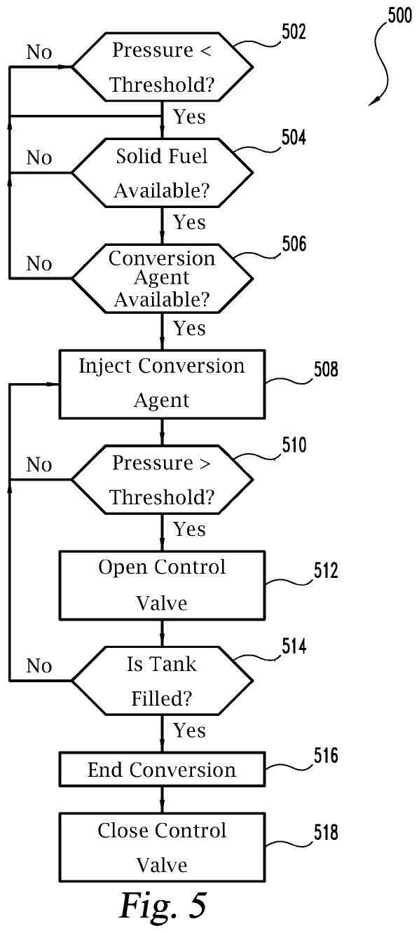

In another embodiment shown in FIG. 5, a method 500 includes a conditional 502 to determine if a pressure condition in second fuel tank 40 is less than a threshold associated with a re-fill condition of second fuel tank 40. If conditional 502 is NO, method 500 continues to monitor the pressure, temperature, and/or fuel level of second fuel tank 40 to identify a re-fill condition. If conditional 502 is YES, method 500 continues at conditional 504 to determine if solid hydrogen fuel 32 is available in first fuel tank 30. If conditional 504 is YES, method 500 continues at conditional 506 to determine if conversion agent 52 is available. If conditional 504 or conditional 506 is NO, method 500 ends and/or may provide an indication to the driver or operator that a re-fill of first and second fuel tanks 30, 40 and/or third tank 50 is required.

If conditional 506 is YES, method 500 continues at operation 508 to initiate injection of conversion agent 52 with metering and injection unit 56. Alternatively, operation of reactor 60 may be initiated. Method 500 continues at conditional 510 to determine if the pressure and/or temperature of gaseous hydrogen fuel in first fuel tank 30 and/or reactor 60 is greater than a threshold desired to initiate release of the produced gaseous hydrogen fuel 42. If conditional 510 is NO, production of gaseous hydrogen fuel 42 is continued without release to second fuel tank 40. If conditional 510 is YES, second control valve 64 is opened at operation 512 to fill second fuel tank 40 with gaseous hydrogen fuel 42 produced from solid hydrogen fuel 32.

Method 500 continues at conditional 514 to determine if the pressure, temperature, and/or fuel level in second fuel tank 40 is at or greater than a threshold associated with a filled second fuel tank 40. If conditional 514 is NO, gaseous hydrogen fuel production is continued and provided to second fuel tank 40. If conditional 514 is YES, method 500 continues at operation 516 to terminate production of gaseous hydrogen fuel 42 from solid hydrogen fuel 32. At operation 518 the second control valve 64 is closed to terminate filling of second fuel tank 40. Method 500 returns to conditional 502 to monitor pressure, temperature, and/or fuel level in second fuel tank 40 to identify a re-fill condition.

In an embodiment, a threshold associated with a target fill percentage for second fuel tank 40 is more than 75% full. In an embodiment, a threshold associated with a target fill percentage for second fuel tank 40 is between 75%-85% full. In other embodiments, any fill percentage for stopping filling of the gaseous fuel tank is contemplated.

In an embodiment, re-filling of second fuel tank 40 with converted solid hydrogen fuel 32 is terminated in response to one or more conditions. Example conditions include the second fuel tank 40 being full, the solid hydrogen fuel 32 being depleted, conversion agent 52 being depleted, the production rate of gaseous hydrogen fuel is not within a range around the desired production rate, a fault or error associated with first fuel tank 30, a fault or error associated solid hydrogen fuel 32, a fault or error associated with reactor 60, a fault or error associated with third tank 50, a fault or error associated with conversion agent 52, a pump fault or error, a meter fault or error, an injector fault or error, a filter condition, a fault or error associated with a sensor, and/or a fault or error associated with a control valve.

Referring back to FIG. 4, in an embodiment of method 400, the gaseous hydrogen fuel produced from the solid hydrogen fuel 32 is supplied directly to prime mover 22 from first fuel tank 30, such as shown with parallel fuel system 24′ in FIG. 3. In this embodiment, prime mover 22 can be powered with gaseous hydrogen fuel produced from first fuel tank 30 and/or gaseous fuel from second fuel tank 40. The selection of the fuel tank 30, 40 can be made based on any suitable criteria, such as supply levels within each fuel tank 30, 40 and/or the conversion agents 52 in third tank 50. Other criteria for selection of first fuel tank 30 or second fuel tank 40 may include, for example, relative costs of the fuel sources for solid hydrogen fuel and gaseous fuel; operational costs associated with solid hydrogen fuel and gaseous fuel; location of the vehicle 20; availability of solid hydrogen fuel and gaseous fuel for re-filling fuel tanks 30, 40; prime mover and/or vehicle operating conditions and/or capabilities; existing operating conditions; look ahead operating conditions; current and forecasted weather and ambient conditions; traffic conditions; and/or road/route conditions.

In another embodiment of operation of hydrogen fuel system 24′, gaseous fuel from second fuel tank 40 is used for starting and initial operation of prime mover 22. First fuel tank 30 is used thereafter for operation of prime mover 22 once conditions are suitable for converting solid hydrogen fuel to gaseous hydrogen fuel for use in operating prime mover 22.

In another embodiment of operation of hydrogen fuel system 24′, controller 80 selects either first fuel tank 30 or second fuel tank 40 for operation of prime mover 22. The selection can be based on availability of solid hydrogen fuel 32 and gaseous fuel 42 due to supply or infrastructure constraints. The selection of the fuel tank 30, 40 for use to supply fuel can be made automatically based on evaluation of the selection criteria in considered by controller 80, and/or manually by operator or driver input.

In another embodiment of operation of hydrogen fuel system 24′, controller 80 determines an error or fault condition associated with one of first fuel tank 30 and second fuel tank 40. Controller 80 then selects the other of the first fuel tank 30 or the second fuel tank 40 for continued operation of prime mover 22. In an embodiment, the non-selected fuel tank 30, 40 can be disabled from providing gaseous fuel until the fault condition is remedied. In an embodiment, a blending strategy for using both first fuel tank 30 and second fuel tank 40 simultaneously to fuel prime mover 22 is altered to prioritize or more heavily rely on usage of the selected fuel tank 30, 40.

In another embodiment of operation of hydrogen fuel system 24′, controller 80 evaluates an upcoming planned usage of prime mover 22 based on a known work shift, planned route, historical usage data, fleet mission plan, hours of operation, etc. Based on the planned usage, a controls strategy is developed to determine an amount of energy needed and to target filling and usage of the gaseous fuel 42 in second fuel tank 40 so second fuel tank 40 is at or near empty at the end of the planned usage. The solid hydrogen fuel 32 stored in first fuel tank 30 is reserved for unplanned or emergency operation of prime mover 22. This embodiment can be implemented, for example, in the event there is a significant cost difference in using solid hydrogen fuel 32.

In another embodiment of operation of hydrogen fuel system 24, 24′, 124, the temperature of the conversion agent 52 is controlled to produce the desired results for conversion of solid hydrogen fuel 32 into gaseous hydrogen fuel. The pressure in or from first fuel tank 30 during the conversion can be managed by closed loop feedback control based on, for example, the ideal gas law formula. Open loop control of the pressure produced by conversion of the solid hydrogen fuel 32 is also contemplated.

In another embodiment of operation of hydrogen fuel system 24, 24′, 124, the conversion of solid hydrogen fuel 32 to gaseous hydrogen fuel is controlled to occur as needed by second fuel tank 40 or by prime mover 22. The timing and/or amount of the conversion can be based on, for example, a planned route, historical data, a window of look ahead data, and/or predicted energy requirements to complete the route or mission. The conversion of solid hydrogen fuel 32 can be controlled to minimize the size of second fuel tank 40, and/or so that second fuel tank 40 is not full at the end of the planned route or work shift.

In another embodiment of operation of hydrogen fuel system 24, 24′, 124, the conversion of solid hydrogen fuel 32 to gaseous hydrogen fuel is controlled to occur as needed in response to an anticipated output from prime mover 22. The timing and/or rate of the conversion can be based on or scheduled around, for example, an anticipated transient condition of prime mover 22, a mission-related output from the prime mover 22, a scheduled maintenance event, or other look ahead event for prime mover 22 output.

In another embodiment of operation of hydrogen fuel system 24, 24′, 124, the conversion of solid hydrogen fuel 32 to gaseous hydrogen fuel is controlled based on operator input, vehicle location, geo-fence locations, in-mission/out-of-mission usage of prime mover 22, time of day, weather conditions, age/useful life or other condition of the solid hydrogen fuel 32, relative cost of solid and hydrogen gaseous fuels, pressure in first fuel tank 30, and/or predicted energy requirements for operation of prime mover 22 to complete a route or mission.

In another embodiment of hydrogen fuel system 24, 24′, 124, first fuel tank 30 and/or second fuel tank 40 are modularized so that a number of fuel tanks 30, 40 can be provided on vehicle 20 that matches a planned usage of gaseous hydrogen fuel. The selection of the number of first fuel tanks 30 and/or second fuel tanks 40 can be based on a known work shift, planned route, historical usage data, fleet mission plan, hours of operation, number and availability of re-fueling stations during the planned usage, etc. In this way, carrying extra fuel tanks 30, 40 can be reduced or eliminated, preserving space for cargo and reducing vehicle weight.

In another embodiment of operation of hydrogen fuel system 24, 24′, 124 controller 80 determines an error or fault condition associated with an availability of conversion agent 52 and/or third tank 50. The error or fault condition can be, for example, a lack of sufficient conversion agent 52, a quality or condition of conversion agent 52, a temperature or icing of conversion agent 52, a pump fault, a meter fault, and/or an injector fault. Controller 80 initiates conversion of the solid hydrogen fuel 32 in response to an absence of an error or fault condition. The presence of an error or fault condition can result in prioritizing use of second fuel tank 40 and/or providing an indication or output of the error or fault condition to the driver or operator.

In another embodiment of hydrogen fuel system 24, 24′, 124, treatment of the converted gaseous hydrogen fuel output from first fuel tank 30 is contemplated. For example, scrubbing, adsorption, and/or cleaning of the gaseous hydrogen fuel is performed due to contaminates that might be added from conversion agent 52.

In another embodiment of hydrogen fuel system 24, 24′, 124, a start-up system is provided to initiate conversion of solid hydrogen fuel 32 to gaseous hydrogen fuel. The start-up system can include, for example, a conversion agent and heat source to initiate conversion of solid hydrogen fuel 32. The start-up system can be used prior to operating prime mover 22 to starting filling second fuel tank 40 when second fuel tank 40 is empty. In one example, the start-up system is provided on-board vehicle 20 and can also be used as a backup when onboard conditions are insufficient to initiate production of gaseous hydrogen fuel. In another example, the start-up system is a stand-alone system provided in a shop or storage location to provide post-maintenance filling of second fuel tank 40.

In another embodiment of hydrogen fuel system 24, 24′, 124, the timing and/or triggering of a conversion event is initiated based on an anticipated need for gaseous fuel and/or to maintain a minimum desired gaseous fuel supply/range for the vehicle. An anticipated need to trigger a conversion event may be determined based on one or more of an absolute tank pressure of the gaseous fuel tank(s) being less than a threshold; maintaining the supplying tank pressure to be greater than the gaseous tank pressure to maintain available gaseous fuel supply; a vehicle's usage history; and a vehicle's predicted usage based on route, duty cycle, etc. In an embodiment, conversion of solid hydrogen fuel 32 is triggered to convert a remaining amount of solid hydrogen fuel 32 when there is less than a threshold amount remaining and when there is an available capacity for receiving the converted fuel in order to allow for the re-filling or replacement of first fuel tank 30 at a next re-fueling station, such as by the installation of a new or longer range cartridge that contains solid hydrogen fuel 32.

As is evident from the figures and text presented above, a variety of aspects according to the present disclosure are contemplated. According to one aspect, a fuel system for a prime mover is provided. The fuel system includes a first fuel tank including a solid hydrogen fuel convertible to a gaseous hydrogen fuel, the first fuel tank including a first outlet. The fuel system also includes a second fuel tank including a gaseous fuel, the second fuel tank including a second outlet for supplying the gaseous fuel to the prime mover. The first outlet supplies the converted gaseous hydrogen fuel to the second fuel tank or to the prime mover.

In an embodiment, the first fuel tank is upstream of the second fuel tank, and the second fuel tank includes an inlet for receiving the converted gaseous hydrogen fuel from the first fuel tank.

In an embodiment, the first outlet of the first fuel tank is connected to the prime mover in parallel to the second outlet of the second fuel tank.

In an embodiment, the system includes a third tank including a conversion agent, and the conversion agent is delivered to the first fuel tank to convert the solid hydrogen fuel to gaseous hydrogen fuel. In a further embodiment, the conversion agent is water. In a further embodiment, the system includes a condensate collector for collecting condensate produced by the prime mover, wherein the condensate collector is connected to the third tank.

In another further embodiment, an injector that receives conversion agent from the third tank and injects the conversion agent into the first fuel tank. In a further embodiment, the system includes a meter configured to control an amount of conversion agent injected by the injector.

In another further embodiment, the system includes a pump for pumping the conversion agent from the third tank to the first fuel tank, and a filter for filtering the conversion agent.

According to another aspect of the present disclosure, a method for fueling a hydrogen powered prime mover is provided. The method includes converting solid hydrogen fuel stored in a first fuel tank to gaseous hydrogen fuel, and providing the gaseous hydrogen fuel to the prime mover or to a second fuel tank that provides gaseous fuel to the prime mover.

In an embodiment, converting the solid hydrogen fuel stored in the first fuel tank is initiated in response to one or more of: a gaseous hydrogen fuel parameter associated with the second fuel tank falling below a threshold; an availability of gaseous hydrogen fuel to re-fill the second fuel tank; an availability of a conversion agent for conversion of the solid hydrogen fuel to gaseous hydrogen fuel; a relative cost of the solid hydrogen fuel and the gaseous hydrogen fuel; an operating condition of the prime mover; an anticipated output from the prime mover; a route associated with operation of the prime mover; an operator input; a location of the prime mover; a time of day; weather conditions; a pressure in the first fuel tank or the first fuel tank; and a condition of the solid hydrogen fuel.

In an embodiment, providing the gaseous hydrogen fuel includes providing the gaseous hydrogen fuel to the second fuel tank in response to a pressure in the first fuel tank being greater than a pressure in the second fuel tank. In an embodiment, converting the solid hydrogen fuel stored in the first fuel tank includes controlling a pressure or temperature of the first fuel tank to produce gaseous hydrogen fuel from the solid hydrogen fuel.

In an embodiment, converting the solid hydrogen fuel stored in the first fuel tank includes injecting a conversion agent into the first fuel tank that produces gaseous hydrogen fuel from the solid hydrogen fuel. In a further embodiment, the method includes heating the conversion agent prior to injecting the conversion agent. In a further embodiment, a temperature of the conversion agent is controlled in response to a pressure of the first fuel tank. In another further embodiment, the conversion agent includes water collected from combustion in the prime mover.

In an embodiment, converting the solid hydrogen fuel stored in the first fuel tank includes feeding the solid hydrogen fuel to a reactor and converting the solid hydrogen fuel with a conversion agent in the reactor.

In an embodiment, the method includes selecting one of the first fuel tank and the second fuel tank to provide the gaseous hydrogen fuel to the prime mover, and providing gaseous hydrogen fuel to the prime mover in response to the selection.

In an embodiment, the method includes determining an onboard quantity of the solid hydrogen fuel and an onboard quantity of the gaseous fuel available for powering the prime mover, determining an availability of the solid hydrogen fuel and the gaseous fuel for re-fueling, and prioritizing usage of the solid hydrogen fuel and the gaseous fuel in response to the onboard quantities and availability of the solid hydrogen fuel and the gaseous fuel for re-fueling.

While the invention has been illustrated and described in detail in the drawings and foregoing description, the same is to be considered as illustrative and not restrictive in character, it being understood that only certain exemplary embodiments have been shown and described. Those skilled in the art will appreciate that many modifications are possible in the example embodiments without materially departing from this invention. Accordingly, all such modifications are intended to be included within the scope of this disclosure as defined in the following claims.

In reading the claims, it is intended that when words such as “a,” “ ”an,“ ” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A fuel system for a prime mover, the fuel system comprising:
a first fuel tank including a solid hydrogen fuel convertible to a gaseous hydrogen fuel, the first fuel tank including a first outlet;
a second fuel tank including a gaseous fuel, the second fuel tank including a second outlet for supplying the gaseous fuel to the prime mover; and
wherein the first outlet supplies the converted gaseous hydrogen fuel to the second fuel tank or to the prime mover.

2. The fuel system of claim 1, wherein the first fuel tank is upstream of the second fuel tank, and the second fuel tank includes an inlet for receiving the converted gaseous hydrogen fuel from the first fuel tank.

3. The fuel system of claim 1, wherein the first outlet of the first fuel tank is connected to the prime mover in parallel to the second outlet of the second fuel tank.

4. The fuel system of claim 1, further comprising:
a third tank including a conversion agent, wherein the conversion agent is delivered to the first fuel tank to convert the solid hydrogen fuel to gaseous hydrogen fuel.

5. The fuel system of claim 4, wherein the conversion agent is water.

6. The fuel system of claim 5, further comprising:
a condensate collector for collecting condensate produced by the prime mover, wherein the condensate collector is connected to the third tank.

7. The fuel system of claim 4, further comprising:
an injector that receives conversion agent from the third tank and injects the conversion agent into the first fuel tank.

8. The fuel system of claim 7, further comprising a meter configured to control an amount of conversion agent injected by the injector.

9. The fuel system of claim 4, further comprising:
a pump for pumping the conversion agent from the third tank to the first fuel tank; and
a filter for filtering the conversion agent.

10. A method for fueling a hydrogen powered prime mover, the method comprising:
converting solid hydrogen fuel stored in a first fuel tank to gaseous hydrogen fuel; and
providing the gaseous hydrogen fuel to the prime mover or to a second fuel tank that provides gaseous fuel to the prime mover.

11. The method of claim 10, wherein converting the solid hydrogen fuel stored in the first fuel tank is initiated in response to one or more of:
a gaseous hydrogen fuel parameter associated with the second fuel tank falling below a threshold;
an availability of gaseous hydrogen fuel to re-fill the second fuel tank;
an availability of a conversion agent for conversion of the solid hydrogen fuel to gaseous hydrogen fuel;
a relative cost of the solid hydrogen fuel and the gaseous hydrogen fuel;
an operating condition of the prime mover;
an anticipated output from the prime mover;
a route associated with operation of the prime mover;
an operator input;
a location of the prime mover;
a time of day;
weather conditions;
a pressure in the first fuel tank or the first fuel tank; and
a condition of the solid hydrogen fuel.

12. The method of claim 10, wherein providing the gaseous hydrogen fuel includes providing the gaseous hydrogen fuel to the second fuel tank in response to a pressure in the first fuel tank being greater than a pressure in the second fuel tank.

13. The method of claim 10, wherein converting the solid hydrogen fuel stored in the first fuel tank includes controlling a pressure or temperature of the first fuel tank to produce gaseous hydrogen fuel from the solid hydrogen fuel.

14. The method of claim 10, wherein converting the solid hydrogen fuel stored in the first fuel tank includes injecting a conversion agent into the first fuel tank that produces gaseous hydrogen fuel from the solid hydrogen fuel.

15. The method of claim 14, further comprising heating the conversion agent prior to injecting the conversion agent.

16. The method of claim 15, wherein a temperature of the conversion agent is controlled in response to a pressure of the first fuel tank.

17. The method of claim 14, wherein the conversion agent includes water collected from combustion in the prime mover.

18. The method of claim 10, wherein converting the solid hydrogen fuel stored in the first fuel tank includes feeding the solid hydrogen fuel to a reactor and converting the solid hydrogen fuel with a conversion agent in the reactor.

19. The method of claim 10, further comprising:
selecting one of the first fuel tank and the second fuel tank to provide the gaseous hydrogen fuel to the prime mover; and
providing gaseous hydrogen fuel to the prime mover in response to the selection.

20. The method of claim 19, further comprising:
determining an onboard quantity of the solid hydrogen fuel and an onboard quantity of the gaseous fuel available for powering the prime mover;
determining an availability of the solid hydrogen fuel and the gaseous fuel for re-fueling; and
prioritizing usage of the solid hydrogen fuel and the gaseous fuel in response to the onboard quantities and availability of the solid hydrogen fuel and the gaseous fuel for re-fueling.
